(19) United States
(12) Patent Application Publication
(10) Pub. No.: US 2026/0235777 A1
(43) Pub. Date: Aug. 13, 2026

(54) QUANTIFYING AIRBORNE RADON DECAY PRODUCTS AND OTHER RADIONUCLIDES

(71) Applicant: The Center for Applied Radon Research LLC, Denver, CO (US)

(72) Inventor: Kimberley A. WALDRON, Denver, CO (US)

(21) Appl. No.: 19/534,233

(22) Filed: Feb. 9, 2026

Related U.S. Application Data
(60) Provisional application No. 63/755,492, filed on Feb. 7, 2025.

(51) Int. Cl. G01T 1/178

(52) U.S. Cl. CPC G01T 1/178

(57) ABSTRACT

A device may include a radon sensor to measure activity concentration of radon gas in a sample of ambient air. A device may include a particulate sensor to measure an abundance of airborne particulates in the sample of the ambient air. A device may include control logic stored in memory and executable to calculate an equilibrium factor from the measured abundance of airborne particulates in the ambient air. The control logic may be executable to further determine a working level of radon decay products in the ambient air from the calculated equilibrium factor and the measured activity concentration of radon gas.

### CROSS REFERENCE TO RELATED APPLICATIONS

The present application claims priority to U.S. Provisional Patent Application No. 63/755,492, titled “QUANTIFYING AIRBORNE RADON DECAY PRODUCTS AND OTHER RADIONUCLIDES,” and filed on Feb. 7, 2025, which is hereby incorporated by reference for all that it discloses or teaches.

### BACKGROUND

Radon decay products have been classified by the International Agency for Research on Cancer as being carcinogenic to humans, and as airborne particles can be inhaled, lung cancer is a particular concern for people exposed to elevated levels of radon decay products for sustained periods. Because the half-life of radon is only 3.8 days, removing or isolating radon will greatly reduce the hazard posed by the resulting radon decay products. Further, there are relatively simple tests for radon gas, including commercially available radon gas detection devices. As a result, detection of radon gas is used as a proxy for the risk posed by radon decay products.

### SUMMARY

In some aspects, the techniques described herein relate to a radon decay product quantifier including: a radon sensor to measure activity concentration of radon gas in a first sample of ambient air; a particulate sensor to measure an abundance of airborne particulates in a second sample of ambient air; and control logic stored in memory and executable to: calculate an equilibrium factor from the measured abundance of airborne particulates in the ambient air; and determine a working level of radon decay products in the ambient air from the calculated equilibrium factor and the measured activity concentration of radon gas.

In some aspects, the techniques described herein relate to a method of assessing risk from radon including: measuring activity concentration of radon gas in a first sample of ambient air; measuring an abundance of airborne particulates in a second sample of the ambient air; calculating an equilibrium factor from the measured abundance of airborne particulates in the ambient air; and determining a working level of radon decay products in the ambient air from the calculated equilibrium factor and the measured activity concentration of radon gas.

In some aspects, the techniques described herein relate to a radon decay product quantifier including: a radon sensor to measure activity concentration of radon gas in a first sample of ambient air; a particulate sensor to measure an abundance of airborne particulates in a second sample of the ambient air, wherein the abundance of airborne particulates includes one or more of a count of the airborne particulates in the second sample of the ambient air and a mass of the airborne particulates in the second sample of the ambient air; control logic stored in memory and executable to: calculate an equilibrium factor from the measured abundance of airborne particulates in the ambient air, wherein the equilibrium factor is calculated with a multimodal formula, the multimodal formula including a first formula applicable when the abundance of airborne particulates is high and a second formula applicable when the abundance of airborne particulates is low, the second formula being distinct from the first formula; determine a working level of radon decay products in the ambient air from the calculated equilibrium factor and the measured activity concentration of radon gas; assess a health risk posed by the radon decay products from the working level; and actively monitor changes in the working level over time; a display to report one or more of the health risk and the working level compared against a threshold to a user.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example radon decay product quantifier.

FIG. 2 illustrates a graph showing an example effect of particulate count on working level.

FIG. 3A illustrates a graph showing an example formula for calculating an equilibrium factor based on a particulate count.

FIG. 3B illustrates a graph showing an example second formula for a multimodal formula.

FIG. 4 illustrates an example method of quantifying radon decay products.

FIG. 5 illustrates an example computing system for use in implementing the described technology.

### DETAILED DESCRIPTIONS

When radon gas alone is measured, its activity concentration may be converted to the level of radon decay products by assuming a fixed value for F %, the equilibrium factor, which is usually assumed to be 40% or 50%. The value of F % may vary widely between 10% and 80% depending on environmental conditions. Thus, the assumption of an F % value equal to 40% or 50% can introduce a significant source of error, which is why radon decay product measurements may be the gold standard measurement method. The measurement of radon decay products may be difficult because of the high cost of measuring devices compared to inexpensive radon gas measurement devices.

Homes, schools and commercial buildings that desire radon mitigation may identify the risk from radon by measuring the level of radon gas in the lowest occupied level of the structure (or, for real estate transactions, the lowest habitable level of the structure). However, as radon gas itself is not of particular concern as it is not retained in the lung tissue, there may be limitations to using radon gas detection as a proxy for radon decay product detection.

Radon decay products are part of the decay chain of uranium-238, which may be found in soils and some building materials. All of the species in the chain are solids at regular temperatures except radon-222. Radon-222, described herein as “radon gas,” is a radioactive gas that can travel out of soil and building materials and into structures where it decays to produce the subsequent species in the chain, specifically at least Po-218, Bi-214, Pb-214 and Po-214, which are referred to herein collectively as radon decay products (RDPs). These four RDPs may be important because they all have short half-lives, and thus they form in quick succession over about an hour once radon gas undergoes alpha decay. Typically, Pb-210 is not included among RDPs because it has a long half-life and is therefore not considered a contributor to radon-induced lung cancer. Of these four short-lived RDPs, Po-218 and Po-214 may be the most dangerous because they undergo alpha decay, and alpha particles are thought to be the direct cause of radon-induced lung cancer, which is initiated when Po-218 and Po-214 are inhaled and deposited in the lung tissue.

Because radon gas is not retained to a significant extent in the lung tissue, but RDPs are, the level of RDPs may be the most direct indicator of health risk due to the presence of radon. Thus, when only the concentration of radon gas is measured, an important assumption is involved: the value of the radon gas concentration is a surrogate (or proxy) for the concentration of RDPs. The units typically used to express the levels of RDPs are working level (WL) or milli-working level (mWL). For this reason, instruments that measure RDPs are often called “working level monitors” or “WL monitors”. The presently disclosed technology, which may include an improved working level monitor, combines a measurement of radon gas concentration with an airborne particulate measurement.

When an atom of radon gas decays, the majority of RDPs have electrostatic charges. This generally causes the RDPs to have two fates: 1) they can bind quickly and tightly to airborne particles (such as dust, smoke, etc.), or 2) they can “plate out”, which means that they adhere to a surface and stick firmly to it. It is also possible for an airborne particle bound to an RDP to plate out once formed. Regardless, RDPs that have plated out are no longer in breathable air, therefore they do not contribute to the dose of RDPs that eventually can lead to lung cancer.

To understand the health risk due to the presence of radon gas, it may be important to know how many RDPs remain airborne and how many have plated out. Equilibrium factor “F” is the fraction of the radon gas atoms in a space that remain airborne and breathable:

$$Fraction of RDPs that remaining airborne = F = \frac{( airborne RDP activity in WL units ) ( 100 )}{radon gas activity in \frac{pCi}{L} units} \qquad Eqn . 1$$

Thus, a fraction of RDPs that plate out is equal to 1−F. The value of F may be expressed in fraction form, which is the form that results when Equation 1 is used. The value of F may also be expressed as the percentage F %, where F %=F×100.

The term “activity” “or activity concentration” is often used in place of “concentration” to quantify radionuclides such as radon gas because energy is quantitated when the radionuclides decay. Therefore, concentration of atoms or ions is not measured as in traditional chemistry. “Activity concentration” and “activity” may report the same thing: the energy emitted when the radionuclide decays. The term “working level” refers to a detected level of RDPs, which is also sometimes referred to as PAEC. PAEC stands for potential alpha energy concentration and may be expressed in units of nJ m⁻³.

RDPs were first measured in underground mines in 1900's and served as the basis for determining worker exposures to radon gas and its decay products. Guidance developed from the miner data and occupational health studies led the US EPA to establish a public exposure guidance of 0.020 WL for RDPs. Today, the public exposure guidance is set at 0.016 WL. The US EPA estimates that the value of F is roughly 0.40 to 0.50. Based on these numbers, the radon gas activity was estimated using a rearranged version of the foregoing equation 1 for calculating F. Setting F=0.50, and the original RDP reference level of 0.020 WL, a radon gas activity concentration public exposure guidance may be calculated as follows:

$$radon gas activity concentration = \frac{RDPs ( WL ) \times 100}{F} = \frac{0.0 \; 20 WL \times 100}{0.50} = 4. pCi / L \qquad Eqn . 2$$

To understand the health risk due to the presence of radon gas, it may be important to know how many RDPs remain airborne and how many have plated out. Equilibrium factor F is the fraction of the radon gas atoms in a space that remain airborne and breathable. The current US EPA radon gas action level of 4.0 pCi/L is derived from the RDP guidance and an assumption that, of the RDPs formed from radon gas, 50% remain suspended in the breathing space (an assumption that F %=50%).

The equilibrium factor F is a variable that may range from roughly 0.10 to 0.80, and that number depends on the abundance of particulate matter in the air. That is, a relationship exists that relates particulate matter to the value of F because they vary together; as particulate matter abundance increases, the value of F increases. Thus, an assumption that F=0.5 can be problematic and can cause radon gas measurements to be an unreliable surrogate for an RDP measurement. This can lead to under-reporting or over-reporting of radon-induced lung cancer risk. This is particularly the case in recent decades where efforts to reduce particulate exposures have increased with the use of high efficiency filters in building HVAC systems as well as efforts to reduce ambient particulate emissions in industrial areas. A radon gas measurement does not account for the effects of particulate reduction efforts or the benefits of these indoor air quality measures. Conversely, in situations of high ambient particulates, such as occupied structures near industrial areas or areas downwind of wildfire events, the actual health risk from RDPs is much higher than would be estimated from a measurement of radon gas alone. The presently disclosed technology accounts for this airborne particulate variability. More specifically, the presently disclosed technology addresses both under-reporting and over-reporting of the health risk posed by the presence of radon by determining an F value, rather than using an assumed average F value as found in many previous methods.

There are three types of devices that have traditionally been used to quantitate RDPs. First, a traditional working level (WL) monitor may continuously measure RDPs by pulling air through a filter at a known flow rate. A detector may then measure alpha decay activity on the filter, which is used as a quantitative measure of RDPs that emit alpha particles (Po-218 and Po-214).

Second, an alpha-sensitive plastic substrate mounted into a holder may be used to measure RDPs. This device, which may be referred to as an “open-faced alpha track”, is nicked when alpha particles strike the surface. The nicks in the surface are counted with a specialized microscope, and that count is correlated to the activity of RDPs in the air.

Third, an Electret Radon Progeny Integrating Sampling Unit (ERIPSU), which is comprised of a two-dimensional surface to which a charge is applied, may be used to measure RDPs. The surface is enclosed in a chamber, which is exposed to room air. The surface has a starting voltage, and that voltage dissipates proportionately with the impingement of ions created when alpha particles from RDPs pass through a known air volume within the device chamber. The resulting change in detector surface voltage may be used to determine the activity concentration of RDPs.

The first general type of RDP quantitation device discussed above, the traditional WL monitor, may require that the flow rate be measured and known accurately at each use. Furthermore, the air pump in the device can be noisy. The filter can become clogged with particulates in heavily polluted or high-smoke areas. Some such devices further present a complicated technology requiring multiple calibrations of scintillation cells, pump air flows and repetitive replacement of sampling components, all of which require a highly trained operator, rendering the device inappropriate for use by the general public. The presently disclosed technology lacks many or all of these and other shortcomings of traditional WL monitors.

The second and third types of RDPs quantitation devices, open-faced alpha tracks and ERIPSUs, utilize integrative methods. As a result, the data is not continuously collected, but instead one value is collected at the end of a measurement, which typically is a minimum of 48 hours. A result is available after the plastic substrate or charged surface has been exposed over a given time period and/or the device must be sent to a lab for microscopic analysis. This precludes such devices from functioning as a continuous feedback mechanism for monitoring HVAC systems. The presently disclosed technology may function as a continuous feedback mechanism and thus lacks many or all of these and other shortcomings of open-faced alpha tracks and ERIPSUs.

The presently disclosed technology utilizes a direct measurement of the parent radionuclide (radon-222) and environmental factors that affect the fraction of RDPs (given by the equilibrium factor, F) that remain suspended after some RDPs attach to physical surfaces, such as walls, or plate-out. This technology may be applied with a variety of radon measuring devices including, but is not limited to, a continuous radon monitor, a container of charcoal, an alpha track device or any other means used to measure radon gas. The technology may further be applied with a variety of particulate sensors. In one implementation, the particulate sensor is designed for use indoors. It may be disadvantageous to use data on the abundance of airborne particulates from external sources such as PM 2.5 municipal data as this data may not accurately reflect the abundance of airborne particulates in the particular indoor space being measured. However, a variety of different particulate sensors that measure the abundance of airborne particulates may be used with the technology, both those described below and other particulate sensors.

As shown by equation 1, the activity concentration of airborne RDPs is directly proportional to the number of airborne particles. That is, the greater the particle load in a given space, the greater the fraction of RDPs that remain airborne and the lower the fraction of RDPs that plate out. This is due to the fact that when particles are plentiful and suspended in the breathing space, RDPs collide with them and attach to them very quickly. When airborne particles are not plentiful, a greater fraction of RDPs will contact interior surfaces and plate out, and they are no longer available for inhalation. Therefore, the value of F goes up when particle counts are high, and the value of F goes down when particle counts are low. Thus, there is a mathematical relationship between the value of F and the number of airborne particles that can be measured in terms of either particle count or mass concentration (as PM_{2.5}, for example).

As described above, traditional RDP monitors have measured RDPs directly by capturing them on a filter and measuring the alpha counts from Po-218 and Po-214. However, this method has drawbacks, as discussed above. In one implementation, the presently disclosed technology does not utilize a direct measurement of RDPs, but rather measures a quantity of radon gas and determines F. The determination of F is possible because F and particle count/mass concentration are proportional to each other and change together. By rearranging the foregoing equation for calculating F, airborne RDPs can be calculated, if F and the activity of radon gas are known, as follows:

$$airborne RDPs ( WL ) = \frac{( F ) ( radon gas ( \frac{pCi}{L} ) )}{100} \qquad Eqn . 3$$

Rather than measuring RDPs directly, the presently disclosed technology may measure suspended particles that directly affect the activity concentration of airborne RDPs to determine the equilibrium factor, F. As used herein, P_{A} refers to a quantification of the abundance of particles-whether by mass concentration or count or some other method. In one implementation, by measuring radon gas and P_{A}, the presently disclosed technology does not rely upon the use of filters and noisy air pumps but rather on measurement devices that may unobtrusively report RDPs (and radon gas levels) for a proper characterization of pulmonary health risk. The data may be continuously or periodically collected, thereby allowing the presently disclosed technology to be used as a real time monitor or a periodic feedback device. As it measures in real time, the presently disclosed technology can function as a feedback device for building air quality management approaches such as ventilation systems to control multiple variables including, but not limited to, radon gas, RDPs, suspended particles, humidity and temperature.

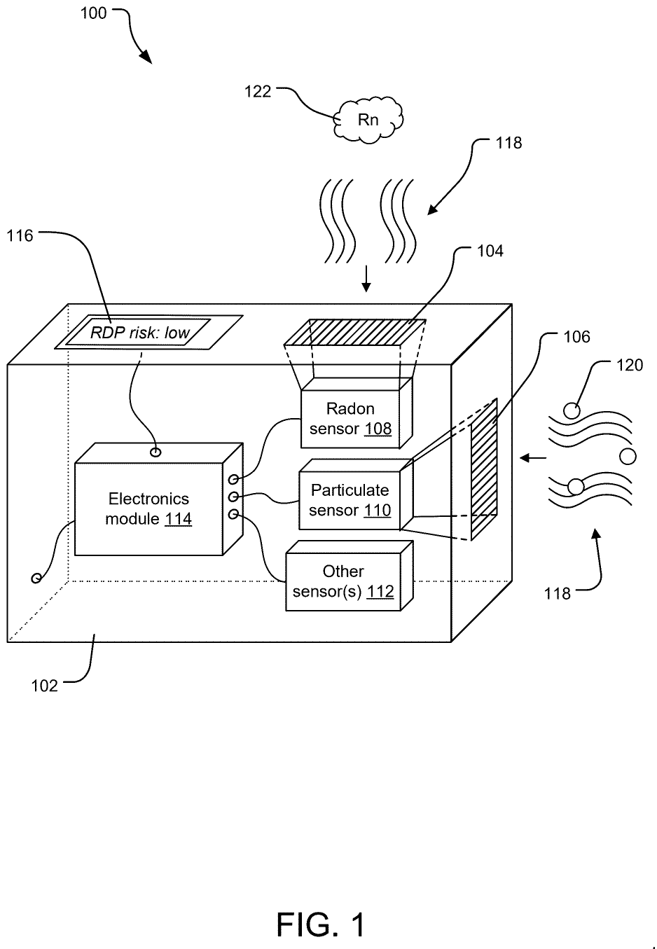

FIG. 1 illustrates an example radon decay product quantifier 100. The radon decay product quantifier 100 includes a radon sensor 108 to measure an activity concentration of radon gas (e.g., radon gas 122) in a first sample of ambient air. The activity concentration may quantify the amount of the radon gas present in the ambient air. The radon decay product quantifier 100 further includes a particulate sensor 110 to measure an abundance of airborne particulates (e.g., particulate 120) in a second sample of the ambient air. The abundance of airborne particulates (“P_{A}”) may quantify the airborne particulates, such as by measuring a mass concentration or count of airborne particulates in the ambient air.

The radon decay product quantifier 100 further includes control logic stored in memory. The control logic is executable to calculate an equilibrium factor from the measured abundance of airborne particulates in the ambient air. The equilibrium factor (“F”) may represent a fraction of radon decay products in a space that remain airborne and breathable. The control logic is further executable to determine a working level of radon decay products in the ambient air from the calculated equilibrium factor and the measured activity concentration of radon gas. The working level (“WL”) may quantify a concentration of the radon decay products (“RDPs”) present in the ambient air. The working level may accurately inform a user of the risk from RDPs present in the space. The radon decay product quantifier 100 may operate continuously, automatically, and without a specialized technician, making the radon decay product quantifier 100 a much more practical system than previous working level monitors.

The radon decay product quantifier 100 may be used in a variety of settings. In the example implementation illustrated in FIG. 1, the radon decay product quantifier 100 is a standalone device that may be placed in a space to determine the working level of RDPs in the space. The radon decay product quantifier 100 illustrated is housed inside a metal or plastic chassis 102 and intakes air (e.g., airflow 118) from the surrounding environment to obtain data on the abundance of airborne particulates and the activity concentration of radon gas. The radon decay product quantifier 100 may use this data to determine the working level of RDPs. In the implementation shown in FIG. 1, the radon decay product quantifier 100 displays a risk level on a digital display 116, though the radon decay product quantifier 100 may also display the working level. The working level may be expressed as a PAEC or potential alpha energy concentration, with the units of nanojoules per cubic meter. In other implementations, other units may be used to measure the activity concentration of the radon gas.

As discussed above, the radon sensor 108 measures the activity concentration of the radon gas in the first sample of ambient air. While radon gas may be colorless and odorless, the radon sensor 108 may detect alpha particles in the first sample of the ambient air. In one implementation, the radon sensor 108 includes a pump to circulate or route the first sample of the ambient air through the radon sensor 108. In another implementation, diffusion may route the first sample through the radon sensor 108. A radon sensor vent 104 may prevent objects that are not the first sample or the radon gas from entering the radon sensor 108. The radon sensor 108 may include passive or active air circulation.

The first sample of ambient air may include the ambient air that travels through the radon sensor 108. The first sample may be distinct from the second sample of ambient air, some gases may overlap between the first sample and the second sample, or the first sample and the second sample may include the same gases. In one implementation, the first sample may be the same as the second sample. As discussed above, the activity concentration may quantify the amount of radon gas present in the space or the energy being emitted from decaying radon gas in the space. The activity concentration may be expressed as pCi/L (“picoCuries per liter”) or Bq/m3 (“Becquerels per meter cubed”). In one implementation, the activity concentration may be expressed as a function of particulate size or room humidity.

Notably, in one implementation, the radon sensor 108 does not measure a level of RDPs. Measuring RDPs may be difficult, require specialized equipment or skills, or take a long time, preventing continuous monitoring. However, the level of RDPs may be determined from the activity concentration of radon gas itself and the F value determined by the mathematical relationship using the above equations, such as equation 3. Therefore, measuring the activity concentration of radon gas may be one step in determining the working level of RDPs and may be more practical than alternative routes.

As discussed above, the particulate sensor 110 measures the abundance of airborne particulates in the second sample of the ambient air, where the abundance of airborne particulates (“P_{A}”) may include a mass, mass concentration, volume, or count of airborne particulates in the second sample of ambient air. Similar to the radon sensor 108, the particulate sensor 110 may either include a pump to circulate or route the second sample of ambient air through the particulate sensor 110 or may use diffusion to route the second sample through the particulate sensor 110. A particulate sensor vent 106 may prevent particulates that are not the second sample or the particulates from entering the particulate sensor 110. In one implementation, the particulate sensor 110 is an SPS30 sensor from Sensirion, which measures approximately 4.0 cm×4.0 cm×1.2 cm. The SPS30 sensor may contain a small fan as well as a 660 nm class 1 laser, which measures the abundance of airborne particulates using traditional Mie scattering technology. The SPS30 sensor may take ten measurements per second of particle count, the particles being sorted by size (e.g., 300 to 500, 1,000, 2,500, 4,000, or 10,000 nm particles) measured in #/mL, particle mass (e.g., PM 1.0, 2.5, 4.0, or 10.0) measured in μg m⁻³, and/or average particle size measured in nm. The particulate sensor 110 may include passive or active air circulation.

The abundance of airborne particulates may be measured in various ways. In one implementation, the abundance of airborne particulates includes a particulate count within a volume, expressed as #/mL. The particulate count may be an abundance of airborne particulates expressed as a count or a count per volume. In another implementation, the abundance of airborne particulates includes a total particulate mass within a volume, expressed as μg m⁻³. In one implementation, various methods may be used to measure the abundance of airborne particulates, provided that the RDP calculation is calibrated for the method used or the variable measured. The abundance of airborne particulates may include another quantification of airborne particulates such as a volume or surface area of airborne particulates. In one implementation, the abundance of airborne particulates does not take into account particulates with a diameter less than 300 nanometers.

As discussed above, the radon decay product quantifier 100 includes memory and the control logic is stored in the memory. The control logic may include software designed to perform calculations and determinations for the radon risk calculator. For example, the control logic may be executable to take in data from the sensors (e.g., radon sensor 108 and particulate sensor 110) and apply the disclosed equations to calculate the equilibrium factor and determine the working level. The control logic may be executable by a processing system. In one implementation, an electronics module 114 houses the memory and the processing system. The electronics module 114 may include an external information connection such as a Wi-Fi or Bluetooth transceiver to intake data from external sources. The control logic may process and use the external data for the calculation of the equilibrium factor or the determination of the working level. In one implementation, the external data includes one or more of an altitude of the radon decay product quantifier 100, a humidity in the area local to the radon decay product quantifier 100, and a temperature in the area local to the radon decay product quantifier 100.

In the implementation discussed above where the particulate sensor 110 does not measure particulates with a diameter less than 300 nanometers, the control logic may be executable to extrapolate an abundance of ultrafine particulates. In this context, ultrafine particulates may include particulates with a diameter less than 300 nanometers. The abundance of ultrafine particulates may quantify the ultrafine particulates. It may be difficult or expensive to measure the abundance of ultrafine particulates. Therefore, it may be beneficial for the control logic to be executed to extrapolate or estimate the abundance of ultrafine particulates. This abundance of ultrafine particulates may influence the calculation of the equilibrium factor. For example, the measured and extrapolated abundance of airborne particulates may be combined to calculate the equilibrium factor.

The working level may be determined using the above equation 3. In other words, the working level of the radon decay products is determined by multiplying the equilibrium factor by the activity concentration of the radon gas. Depending on the units used for the equilibrium factor and the activity concentration, the above product of the equilibrium factor and the activity concentration may be multiplied by a constant in order for the equation to output the desired units for the working level.

As discussed above, the radon decay product quantifier 100 may ultimately determine the working level of RDPs present in the space around the radon decay product quantifier 100. This may be important as the RDPs, not the radon gas itself, pose a serious health risk to humans when inhaled, and the health risk from RDPs depends on the abundance of particulates present in the air. The working level accounts for both the activity concentration of the radon gas, which may be indicative of how many RDPs are present, as well as the abundance of particulates present. Because of this, the working level may be an accurate indicator of the health risk posed by RDPs. Notably, it may be difficult to quantify the health risk posed by RDPs, though the working level may be a reasonable estimate of the health risk.

In one implementation, the determination of the working level is adjusted by correction factors. The correction factors may include the humidity of the ambient air, the altitude of the radon decay product quantifier 100, the abundance of ultrafine particulates, and more. It may be important to use the correction factors to adjust the determination of the working level when the correction factors influence the working level. In one example implementation, the humidity of the ambient air affects the working level of the RDPs, so the determination of the working level takes into account the humidity of the ambient air to determine an accurate working level.

As mentioned above, the radon decay product quantifier 100 includes the display 116 to report the working level. The display 116 may be located on one side of the chassis 102. In one implementation, the display 116 also reports a threshold which indicates a working level that may present risk to people in the surrounding space. The threshold, which may include a guidance level, may come from a health authority. For example, the US EPA states that a working level of radon gas of 0.020 WL is one possible threshold above which RDPs present a health risk. In another implementation, a different threshold may be used. In one example implementation, multiple thresholds may be used, such as a first threshold of 0.010 WL, below which is indicated as safe, a second threshold of 0.020 WL, below which but above the first threshold is indicated as somewhat risky, and above which is indicated as risky. In one implementation, the radon decay product quantifier 100 may send notifications to users if the working level rises above a certain threshold. The notification may be sent over Wi-Fi or the internet. In one implementation, the radon decay product quantifier 100 reports the working level to a mobile device of a user such that the user is able to check the working level while remote from the radon decay product quantifier 100. The radon decay product quantifier 100 may include additional functionality to monitor health risks in the space surrounding the radon decay product quantifier 100. In one implementation, the control logic is further executable to assess the health risk posed by the RDPs. In one implementation, the health risk is assessed by comparing the working level to the one or more thresholds or guidance levels. This health risk may be reported on the display 116, for example using color-coding such as red to indicate “risky”, yellow to indicate “possible risk” and green to indicate “low risk.”

The control logic may be further executable to actively monitor changes in the working level over time. For example, the control logic may periodically be executed to determine the working level. If the working level changes, the display 116 may update the reported working level and the reported health risk. By continuously monitoring and reporting the working level and the health risk, the radon decay product quantifier 100 may report accurate and up-to-date information, allowing users to see rises, falls, and spikes in the working level. This may be important to keep people in the surrounding space safe from the risk posed by RDPs.

The radon decay product quantifier 100 may include an additional sensor (e.g., other sensor(s) 112). The additional sensor may measure other properties of a third sample of the ambient air or the surrounding space, aside from an abundance of particulates and an activity concentration of radon gas. The additional sensor may include a vent to the outside of the radon decay product quantifier 100 to allow the third sample to circulate through the additional sensor. The radon decay product quantifier 100 may further include a fan to more quickly circulate the third sample through the vent. In another implementation, the third sample is circulated through the additional sensor via diffusion. In one implementation, the radon decay product quantifier 100 includes vents to prevent debris from entering the additional sensor.

The additional sensor may measure one or more of a variety of properties. In one implementation, the additional sensor is a barometer to measure the pressure of the third sample of ambient air. In another implementation, the additional sensor measures the humidity of the third sample. The additional sensor may also measure the altitude of the radon decay product quantifier 100. In these examples, the pressure, humidity, and/or altitude of the ambient air may affect the working level of RDPs in the ambient air. For example, a lower pressure or higher altitude may decrease the density of ambient air, causing fewer particulates to be present in the ambient air. In one implementation, this effect is also accounted for by the particulate sensor 110. In another example, a higher humidity of the ambient air may affect the working level by changing the static charge of the particulates, which influences the static force of attraction between the particulates and the RDPs. In turn, this may lead to fewer RDPs attaching to particulates, leading more RDPs to plate out. In one implementation, this effect is not accounted for by the particulate sensor 110. The measurement from the additional sensor may be used to determine the working level of the RDPs in the ambient air.

In one implementation, the radon decay product quantifier 100 may be used in conjunction with a separate fan and a separate filter to reduce the abundance of airborne particulates in the ambient air. The separate fan may be activated in response to the working level passing the one or more thresholds or in response to the health risk reaching a certain level. In another implementation, the separate fan is activated whenever the radon decay product quantifier 100 is powered. In yet another implementation, the separate fan is driven faster as the working level increases. The separate fan and the separate filter may reduce the risk from the RDPs identified by the radon decay product quantifier 100, acting as a complementary system.

The presently disclosed technology may be manufactured and sold as a component of a forced air heating, ventilation, and air conditioning (HVAC) system. Its function may be to measure RDPs and provide feedback data to a control system that modulates air flows through the HVAC filter system. In one implementation, the air filtration system, which captures a significant portion of RDPs passing through, may be integral to the HVAC system or a stand-alone air filtration system. The presently disclosed technology may be incorporated into built environments of different sizes, from a simple forced air system in a residence to large HVAC system(s) in a commercial building or school. The presently disclosed technology may also be used to track the effectiveness of particulate reduction devices commonly used to improve indoor air quality. The presently disclosed technology may be manufactured as a stand-alone, research-grade RDP measurement device. The precision and accuracy of the presently disclosed technology may depend in part on the sensitivity of the sensors used.

The presently disclosed technology may be incorporated into portable console air cleaners with a feedback mechanism that would modulate air flows as a function of RDP levels. This may be technically advantageous in situations where RDP reductions in a single room are needed or in the advent of temporary high particulate exposures (e.g., the presence of wildfire smoke). The console air cleaner, which may be used for single rooms or smaller spaces, could include the presently disclosed technology as a module within the console air cleaner including functional components. A feedback loop to the console air cleaner may increase air flow for filtration when RDPs are elevated.

The presently disclosed technology may be incorporated into existing commercial radon gas measuring devices, thus allowing for an expansion of their capabilities at little cost. The presently disclosed technology may also quantify other airborne radionuclides other than RDPs by incorporating sensors specific to that radionuclide.

The presently disclosed technology may be applied to quantifying occupational exposures to RDPs in workplaces such as office buildings, underground mines, etc., either as an area monitor or a personal dosimeter. The presently disclosed technology may be applied to ambient air monitoring for compliance with ambient air standards and measurement of ambient background radionuclide levels for regulatory monitoring both indoors and outdoors.

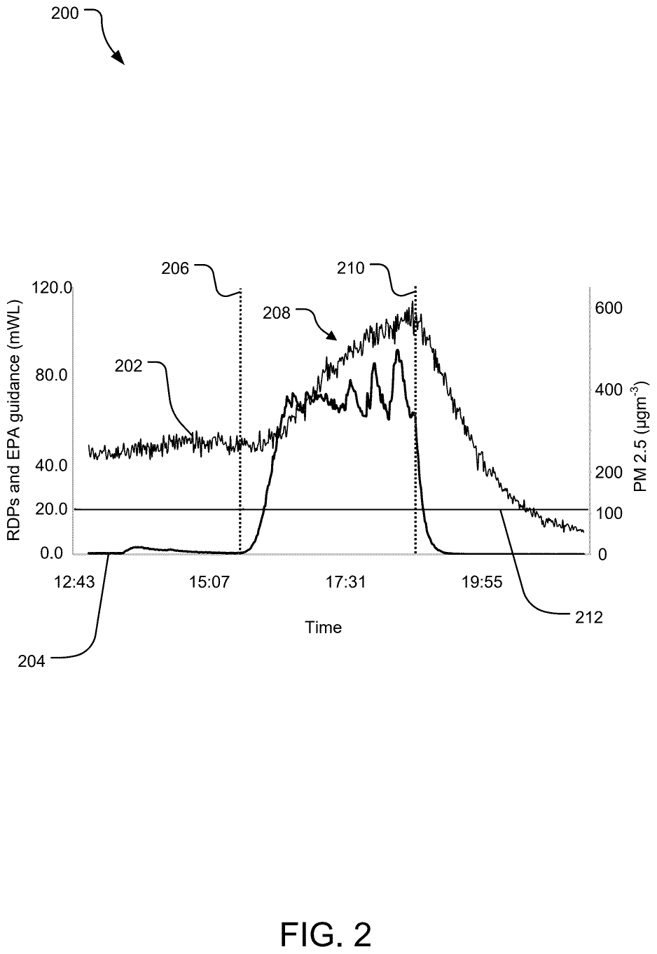

FIG. 2 illustrates a graph 200 showing an example effect of particulate count on working level. The graph 200 illustrates an example scenario where, despite the activity concentration of radon gas being held constant, the working level (see working level 202) varies dramatically because of the changing particulate count (see particulate count 204). The graph 200 illustrates the principle that the particulate count affects the working level in a predictable way. Throughout the scenario, because the activity concentration of radon gas is held constant, if one used an assumed value for the particulate count, they would determine a constant working level throughout the graph 200. However, this is not what FIG. 2 illustrates. The graph 200 shows that, to determine an accurate working level, one should take the particulate count into consideration.

In the example scenario, an example radon decay product quantifier may be measuring the particulate count and determining the working level for a room. The working level starts off at around 50 milliworking levels (mWL), while the particulate mass concentration, expressed here as PM2.5, is very low, below 5 micrograms per cubic meter. Then, at time 205, particulates are pumped into the room. This is illustrated in FIG. 2 by the rise in the particulate count 208. In the example scenario, radon gas levels in the test room are maintained at a constant level (not shown). In response to particulates being pumped into the room, the RDP levels rise. This may occur because the RDPs being generated by the presence of radon gas adhere to added particulates and remain airborne (and plate out less frequently). For a given abundance of particles, RDPs may reach a characteristic level at a constant radon gas activity concentration. This relationship may be the basis for the formula used to relate particles to F %.

Then, at time 210, an air cleaner is activated and the particulates are removed by filtration. This is illustrated in FIG. 2 by the drop in the particulate count. Corresponding to this drop, the working level also decreases. This example scenario shows that the particulate count and the working level are linked. By measuring and taking into consideration the particulate count, the working level may be determined.

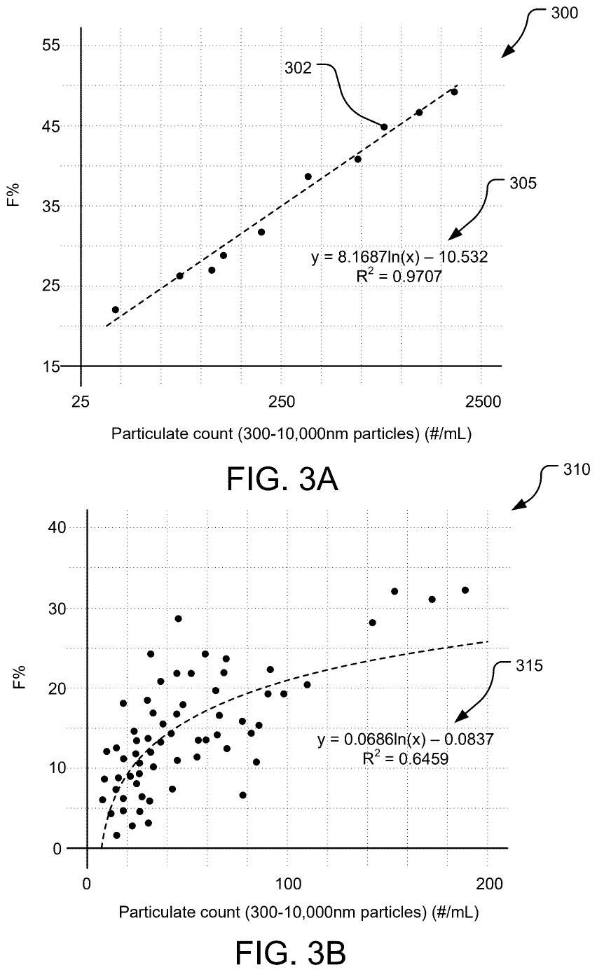

FIG. 3A illustrates a graph 300 showing an example formula 305 for calculating an equilibrium factor based on a particulate count. The formula 305 may be acquired by measuring the equilibrium factor for various particulate counts, plotting the data graphically, and generating a line of best fit. FIG. 3A illustrates various datapoints (e.g., datapoint 302) that may be used to determine the formula 305. In FIG. 3A, the equilibrium factor is measured on the y-axis as a percentage while the particulate count is measured on the x-axis as a count per milliliter. The particulate count may include only particulates with a diameter between 300 and 10,000 nanometers. In other implementations, the particulate count may include particulates with a diameter less than 300 nanometers including ultrafine particulates.

The graphed line of best fit may determine the formula 305 for finding the equilibrium factor. In FIG. 3A, the formula 305 from the line of best is F=8.1687ln (P_{A})−10.532. This formula 305 means that the equilibrium factor can be calculated as 8.1687 times the natural log of the particulate count, minus 10.532. Control data stored in memory and executable by a processing system may use the formula 305 to calculate the equilibrium factor.

In an implementation such as FIG. 3A, the formula 305 and the line of best fit may not have a y-intercept of 0. This may not make intuitive sense, as the equilibrium factor is the portion of RDPs that remain airborne, and if no particulates are airborne, all the RDPs may plate out. Therefore, it may make intuitive sense for the equilibrium factor to be zero when the particulate count is zero. It may then be rational to set the y-intercept of the formula 305 to zero. However, in one implementation, the formula 305 may be accurate for particulate counts over a certain level such as 100 per milliliter, so adjusting the formula 305 for the y-intercept to be zero may lead to inaccurate equilibrium factors being calculated above the certain level. Therefore, in the one implementation, it may be desirable to have a multimodal formula with a second formula below the certain level.

FIG. 3B illustrates a graph 310 showing an example second formula 315 for a multimodal formula. Similar to the formula 305 in FIG. 3A, the second formula 315 may be determined by a line of best fit through datapoints acquired experimentally. In an implementation with a second formula 315 such as FIG. 3B, the equilibrium factor is calculated with a multimodal formula. The multimodal formula includes first formula applicable when the abundance of airborne particulates is high and the second formula 315 applicable when the abundance of airborne particulates is low. The second formula may be distinct from the first formula. In other implementations, more than two formulas may be used in the multimodal formula. In FIG. 3B, the equilibrium factor is measured on the y-axis as a percentage while the particulate count is measured on the x-axis as a count per milliliter. In one implementation, the particulate count may include only particulates with a diameter between 300 and 10,000 nanometers.

As used herein, the abundance of airborne particulates is “high” when the abundance of airborne particulates is greater than when the abundance of airborne particulates is “low.” Accordingly, the abundance of airborne particulates is “low” when the abundance of airborne particulates is less than when the abundance of airborne particulates is “high.” Therefore, in an implementation with a multimodal formula, two ranges exist: a lower range and an upper range, the upper range covering particulate counts greater than the lower range.

In another implementation, the abundance of airborne particulates is “high” when the particulate count is over the certain level, while the abundance of airborne particulates may be “low” when the particulate count is below the certain level. Therefore, the second formula 315 is used up until the certain level, and then the first formula is used for higher particulate counts. In one implementation, the certain level is 500 particles per milliliter. In this implementation, a low abundance of airborne particulates may be below 200 particles per milliliter, while a high abundance of airborne particulates may be above 200 particles per milliliter. In other implementations, the certain level is 25, 50, 100, 200, 400, or 700 particles per milliliter.

In FIG. 3B, the second formula 315 from the line of best is F=0.0686ln (P_{A})−0.0837. This second formula 315 means that for low abundances of airborne particulates, the equilibrium factor can be calculated as 0.0686 times the natural log of the particulate count, minus 0.0837. Control data stored in memory and executable by a processing system may use the formula 305 to calculate the equilibrium factor. In the second formula 315, the y-intercept may still not be zero, but may be close enough to zero to get accurate determinations of the working level for practical use cases.

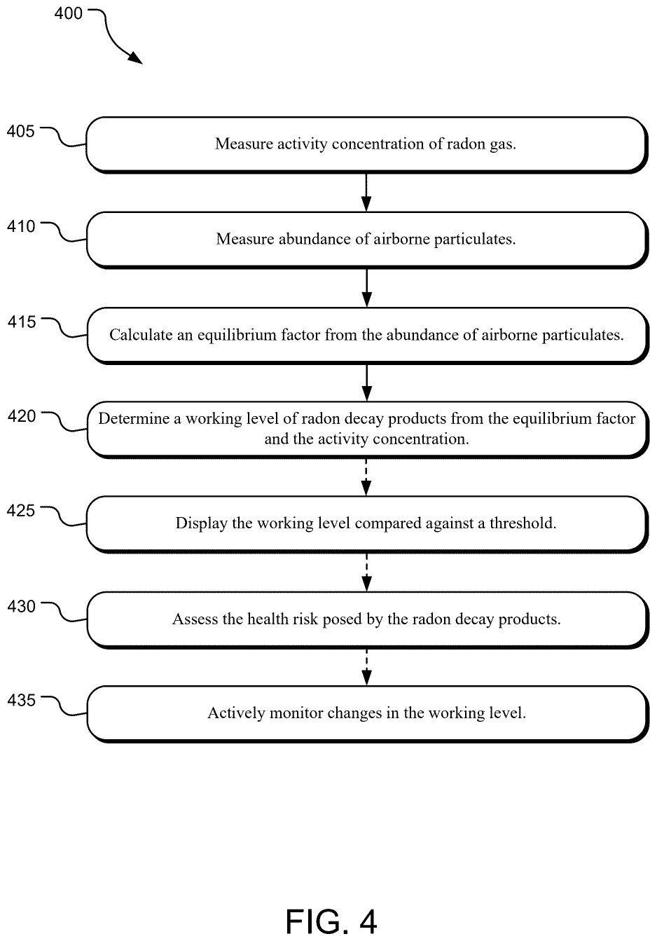

FIG. 4 illustrates an example method 400 of quantifying radon decay products. The method 400 may use a radon decay product quantifier such as the radon decay product quantifiers described in FIG. 1 through FIG. 3B. The method 400 may first include an activity concentration measuring operation 405 to measure the activity concentration of radon gas in a first sample of ambient air. In another implementation, the activity concentration measuring operation 405 may including obtaining the activity concentration of radon gas from another source. The method 400 may further include an abundance measuring operation 410 to measure an abundance of airborne particulates in a second sample of the ambient air. In another implementation, the abundance measuring operation 410 may including obtaining the abundance of airborne particulates from another source.

The method 400 may also include a calculating operation 415 to calculate an equilibrium factor from the measured abundance of airborne particulates in the ambient air. The method 400 may further include a determining operation 420 to determine a working level of radon decay products in the ambient air from the calculated equilibrium factor and the measured activity concentration of radon gas. These operations may accurately, quickly, and possibly constantly determine the working level of radon decay products in the ambient air.

The method 400 may include further optional operations. The method 400 may optionally include a displaying operation 425 to display the working level compared against a threshold to a user. The method 400 may further optionally include a determining operation 430 to determine a health risk posed by the radon decay products. The method 400 may also optionally include a monitoring operation 435 to actively monitor changes in the working level over time.

The equilibrium factor may be calculated with a multimodal formula. The multimodal formula may include a first formula applicable when the abundance of airborne particulates is high and a second formula applicable when the abundance of airborne particulates is low. In another implementation, the different modalities may be based on another measurement different from the abundance of airborne particulates. For example, the different modalities may be based on high and low humidity, high and low radon gas concentrations, high low altitudes, or other data. Furthermore, the data may overlap to for further modalities. For example, the different modalities may be based on a function of altitude and humidity. There may be many different algorithms that may apply in different specific situations.

The second formula may be distinct from the first formula. High and low abundances of airborne particulates may exist whenever two distinct formulas are used, one of which is used above a certain abundance of airborne particulates and the other of which is used below the certain abundance of airborne particulates. In another implementation, the multimodal formula may include several formulas, each applicable within a range of airborne particulate abundance. In one example implementation, the multimodal formula includes three formulas for low, medium and high airborne particulate counts, respectively. In other implementations, the multimodal formula may include four or more formulas.

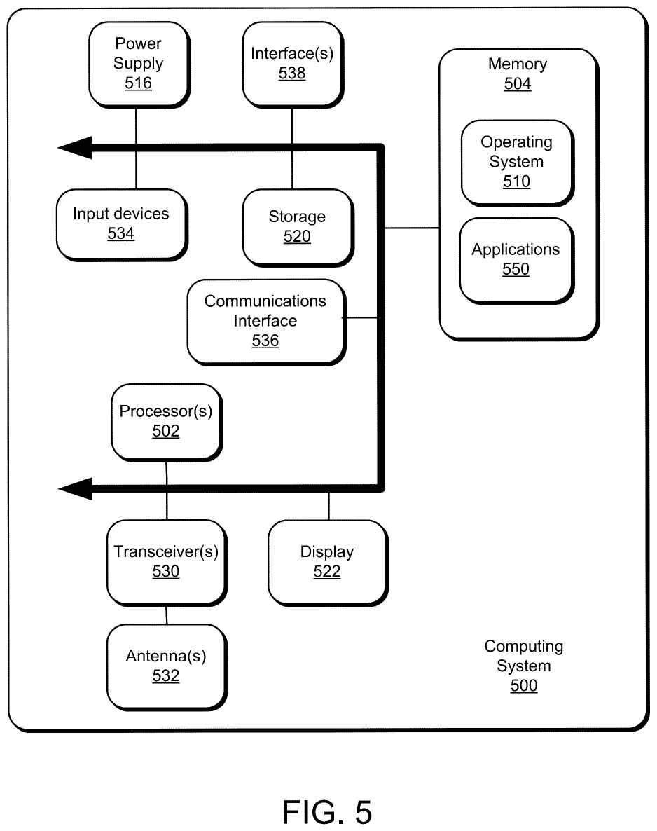

FIG. 5 illustrates an example computing system 500 for use in implementing the described technology. The computing system 500 may include one or more client computing device (such as a laptop computer, a desktop computer, or a tablet computer), a server/cloud computing device, an Internet-of-Things (IoT), any other type of computing device, or a combination of these options. The computing system 500 includes a hardware processor system (including one or more hardware processor(s) 502) and a memory 504. The memory 504 generally includes both volatile memory (e.g., RAM) and nonvolatile memory (e.g., flash memory), although one or the other type of memory may be omitted. An operating system 510 resides in the memory 504 and is executed by the processor(s) 502. In some implementations, the computing system 500 includes and/or is communicatively coupled to storage 520.

In the example computing system 500, as shown in FIG. 5, one or more software modules, segments, and/or processors, such as applications 550, control logic, and other program code and modules are loaded into the operating system 510 on the memory 504 and/or the storage 520 and executed by the processor(s) 502. The storage 520 may store an activity concentration of radon gas, an abundance of airborne particulates, humidity, altitude, air pressure, an equilibrium factor, a working level, a health risk, and other data and be local to the computing system 500 or may be remote and communicatively connected to the computing system 500. In particular, in one implementation, components of a system for quantifying risk from radon may be implemented entirely in hardware or in a combination of hardware circuitry and software.

The computing system 500 includes a power supply 516, which may include or be connected to one or more batteries or other power sources, and which provides power to other components of the computing system 500. The power supply 516 may also be connected to an external power source that overrides or recharges the built-in batteries or other power sources.

The computing system 500 may include one or more communication transceivers 530, which may be connected to one or more antenna(s) 532 to provide network connectivity (e.g., mobile phone network, Wi-Fi®, Bluetooth®) to one or more other servers, client devices, IoT devices, and other computing and communications devices. The computing system 500 may further include a communications interface 536 (such as a network adapter or an I/O port, which are types of communication devices). The computing system 500 may use the adapter and any other types of communication devices for establishing connections over a wide-area network (WAN) or local-area network (LAN). It should be appreciated that the network connections shown are exemplary and that other communications devices and means for establishing a communications link between the computing system 500 and other devices may be used.

The computing system 500 may include one or more input devices 534 such that a user may enter commands and information (e.g., a keyboard, trackpad, or mouse). These and other input devices may be coupled to the server by one or more interfaces 538, such as a serial port interface, parallel port, or universal serial bus (USB). The computing system 500 may further include a display 522, such as a touchscreen display.

The computing system 500 may include a variety of tangible processor-readable storage media and intangible processor-readable communication signals. Tangible processor-readable storage can be embodied by any available media that can be accessed by the computing system 500 and can include both volatile and nonvolatile storage media and removable and non-removable storage media. Tangible processor-readable storage media excludes intangible and transitory communications signals (such as signals per se) and includes volatile and nonvolatile, removable and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing system 500. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

In some aspects, the techniques described herein relate to a radon decay product quantifier including: a radon sensor to measure activity concentration of radon gas in a first sample of ambient air; a particulate sensor to measure an abundance of airborne particulates in a second sample of the ambient air; and control logic stored in memory and executable to: calculate an equilibrium factor from the measured abundance of airborne particulates in the ambient air; and determine a working level of radon decay products in the ambient air from the calculated equilibrium factor and the measured activity concentration of radon gas.

In some aspects, the techniques described herein relate to a radon decay product quantifier, further including: a display to report the working level compared against a threshold to a user.

In some aspects, the techniques described herein relate to a radon decay product quantifier, wherein the abundance of airborne particulates includes one or more of a count of the airborne particulates in the second sample of the ambient air and a mass of the airborne particulates in the second sample of the ambient air.

In some aspects, the techniques described herein relate to a radon decay product quantifier, wherein the measured abundance of airborne particulates in the second sample of the ambient air measures airborne particulates having a diameter greater than 300 nanometers.

In some aspects, the techniques described herein relate to a radon decay product quantifier, wherein the control logic is further executable to extrapolate an abundance of ultrafine particulates in the second sample of the ambient air with a diameter less than 300 nanometers, and wherein the measured abundance of airborne particulates and the extrapolated abundance of airborne particulates are combined to calculate the equilibrium factor.

In some aspects, the techniques described herein relate to a radon decay product quantifier, wherein the determination of the working level is adjusted by correction factors, the correction factors including one or more of humidity, altitude, and an ultrafine particulate abundance.

In some aspects, the techniques described herein relate to a radon decay product quantifier, wherein the equilibrium factor is calculated with a multimodal formula, the multimodal formula including a first formula applicable when the abundance of airborne particulates is high and a second formula applicable when the abundance of airborne particulates is low, the second formula being distinct from the first formula.

In some aspects, the techniques described herein relate to a radon decay product quantifier, wherein the equilibrium factor is calculated with a natural log of a particulate count in the second sample of the ambient air.

In some aspects, the techniques described herein relate to a radon decay product quantifier, wherein the control logic is further executable to determine a health risk posed by the radon decay products.

In some aspects, the techniques described herein relate to a radon decay product quantifier, wherein the control logic is further executable to actively monitor changes in the working level over time.

In some aspects, the techniques described herein relate to a radon decay product quantifier, further including: an additional sensor to measure one or more of: a pressure of a third sample of the ambient air, a humidity of the third sample of the ambient air, and an altitude of the radon decay product quantifier, wherein the measurement from the additional sensor is used to determine the working level of the radon decay products in the ambient air.

In some aspects, the techniques described herein relate to a radon decay product quantifier, wherein the working level of the radon decay products is determined by multiplying the equilibrium factor by the activity concentration of the radon gas.

In some aspects, the techniques described herein relate to a method of assessing risk from radon including: measuring activity concentration of radon gas in a first sample of ambient air; measuring an abundance of airborne particulates in a second sample of the ambient air; calculating an equilibrium factor from the measured abundance of airborne particulates in the ambient air; and determining a working level of radon decay products in the ambient air from the calculated equilibrium factor and the measured activity concentration of radon gas.

In some aspects, the techniques described herein relate to a method 14, further including: displaying the working level compared against a threshold to a user.

In some aspects, the techniques described herein relate to a method 14, further including: determining a health risk posed by the radon decay products.

In some aspects, the techniques described herein relate to a method 14, further including: actively monitoring changes in the working level over time.

In some aspects, the techniques described herein relate to a method 14, wherein the equilibrium factor is calculated with a multimodal formula, the multimodal formula including a first formula applicable when the abundance of airborne particulates is high and a second formula applicable when the abundance of airborne particulates is low, the second formula being distinct from the first formula.

In some aspects, the techniques described herein relate to a method 14, further including: circulating the ambient air through a filter to reduce the abundance of airborne particulates in the ambient air.

In some aspects, the techniques described herein relate to a radon decay product quantifier including: a radon sensor to measure activity concentration of radon gas in a first sample of ambient air; a particulate sensor to measure an abundance of airborne particulates in a second sample of the ambient air, wherein the abundance of airborne particulates includes one or more of a count of the airborne particulates in the second sample of the ambient air and a mass of the airborne particulates in the second sample of the ambient air; control logic stored in memory and executable to: calculate an equilibrium factor from the measured abundance of airborne particulates in the ambient air, wherein the equilibrium factor is calculated with a multimodal formula, the multimodal formula including a first formula applicable when the abundance of airborne particulates is high and a second formula applicable when the abundance of airborne particulates is low, the second formula being distinct from the first formula; determine a working level of radon decay products in the ambient air from the calculated equilibrium factor and the measured activity concentration of radon gas; determine a health risk posed by the radon decay products from the working level; and actively monitor changes in the working level over time; a display to report one or more of the health risk and the working level compared against a threshold to a user.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

While various implementations of the present invention have been described in detail, it is apparent that modifications and adaptations of those implementations will occur to those skilled in the art. However, it is to be expressly understood that such modifications and adaptations are within the spirit and scope of the present invention.

What is claimed is:

1. A radon decay product quantifier comprising:
a radon sensor to measure activity concentration of radon gas in a first sample of ambient air;
a particulate sensor to measure an abundance of airborne particulates in a second sample of the ambient air; and
control logic stored in memory and executable to:
calculate an equilibrium factor from the measured abundance of airborne particulates in the ambient air; and
determine a working level of radon decay products in the ambient air from the calculated equilibrium factor and the measured activity concentration of radon gas.

2. The radon decay product quantifier of claim 1, further comprising:
a display to report the working level compared against a threshold to a user.

3. The radon decay product quantifier of claim 1, wherein the abundance of airborne particulates includes one or more of a count of the airborne particulates in the second sample of the ambient air and a mass concentration of the airborne particulates in the second sample of the ambient air.

4. The radon decay product quantifier of claim 1, wherein the measured abundance of airborne particulates in the second sample of the ambient air measures airborne particulates having a diameter greater than 300 nanometers.

5. The radon decay product quantifier of claim 4, wherein the control logic is further executable to extrapolate an abundance of ultrafine particulates in the second sample of the ambient air with a diameter less than 300 nanometers, and wherein the measured abundance of airborne particulates and the extrapolated abundance of airborne particulates are combined to calculate the equilibrium factor.

6. The radon decay product quantifier of claim 1, wherein the determination of the working level is adjusted by correction factors, the correction factors including one or more of humidity, altitude, and an ultrafine particulate abundance.

7. The radon decay product quantifier of claim 1, wherein the equilibrium factor is calculated with a multimodal formula, the multimodal formula including a first formula applicable when the abundance of airborne particulates is high and a second formula applicable when the abundance of airborne particulates is low, the second formula being distinct from the first formula.

8. The radon decay product quantifier of claim 1, wherein the equilibrium factor is calculated with a natural log of a particulate count in the second sample of the ambient air.

9. The radon decay product quantifier of claim 1, wherein the control logic is further executable to determine a health risk posed by the radon decay products.

10. The radon decay product quantifier of claim 1, wherein the control logic is further executable to actively monitor changes in the working level over time.

11. The radon decay product quantifier of claim 1, further comprising:
an additional sensor to measure one or more of: a pressure of a third sample of the ambient air, a humidity of the third sample of the ambient air, and an altitude of the radon decay product quantifier, wherein the measurement from the additional sensor is used to determine the working level of the radon decay products in the ambient air.

12. The radon decay product quantifier of claim 1, wherein the working level of the radon decay products is determined by multiplying the equilibrium factor by the activity concentration of the radon gas.

13. A method of assessing risk from radon comprising:
measuring activity concentration of radon gas in a first sample of ambient air;
measuring an abundance of airborne particulates in a second sample of the ambient air;
calculating an equilibrium factor from the measured abundance of airborne particulates in the ambient air; and
determining a working level of radon decay products in the ambient air from the calculated equilibrium factor and the measured activity concentration of radon gas.

14. The method of assessing risk from radon of claim 13, further comprising:
displaying the working level compared against a threshold to a user.

15. The method of assessing risk from radon of claim 13, further comprising:
determining a health risk posed by the radon decay products.

16. The method of assessing risk from radon of claim 13, further comprising:
actively monitoring changes in the working level over time.

17. The method of assessing risk from radon of claim 13, wherein the equilibrium factor is calculated with a multimodal formula, the multimodal formula including a first formula applicable when the abundance of airborne particulates is high and a second formula applicable when the abundance of airborne particulates is low, the second formula being distinct from the first formula.

18. The method of assessing risk from radon of claim 13, further comprising:
extrapolating an abundance of ultrafine particulates in the second sample of the ambient air with a diameter less than 300 nanometers, and wherein the measured abundance of airborne particulates and the extrapolated abundance of airborne particulates are combined to calculate the equilibrium factor.

19. The method of assessing risk from radon of claim 13, further comprising:
adjusting the determination of the working level with correction factors, the correction factors including one or more of humidity, altitude, and an ultrafine particulate abundance.

20. A radon decay product quantifier comprising:
a radon sensor to measure activity concentration of radon gas in a first sample of ambient air;
a particulate sensor to measure an abundance of airborne particulates in a second sample of the ambient air, wherein the abundance of airborne particulates includes one or more of a count of the airborne particulates in the second sample of the ambient air and a mass concentration of the airborne particulates in the second sample of the ambient air;
control logic stored in memory and executable to:
calculate an equilibrium factor from the measured abundance of airborne particulates in the ambient air, wherein the equilibrium factor is calculated with a multimodal formula, the multimodal formula including a first formula applicable when the abundance of airborne particulates is high and a second formula applicable when the abundance of airborne particulates is low, the second formula being distinct from the first formula;
determine a working level of radon decay products in the ambient air from the calculated equilibrium factor and the measured activity concentration of radon gas;
determine a health risk posed by the radon decay products from the working level; and
actively monitor changes in the working level over time;
a display to report one or more of the health risk and the working level compared against a threshold to a user.
